(19) United States
(12) Patent Application Publication
(10) Pub. No.: US 2018/0065431 A1
(43) Pub. Date: Mar. 8, 2018

(54) Quick connect hitch receiver plate and connector

(71) Applicant: Darren Keith Mitchell, Milwaukee, WI (US)

(72) Inventor: Darren Keith Mitchell, Milwaukee, WI (US)

(21) Appl. No.: 15/256,669

(22) Filed: Sep. 5, 2016

(51) Int. Cl. B60D 1/52; B60D 1/36; B60D 1/28

(52) U.S. Cl. CPC B60D 1/52; B60D 1/28; B60D 1/363

(57) ABSTRACT

A method for hitching a rolled wagon or cargo system to a standard vehicle hitch allowing for the quick connection and securing to the transport vehicle. Used exclusively for a wagon or cargo load capable of raising the load itself before having the load lowered on the hitch receiver assembly. Conversely the hitch allows for the quick disconnect and unhitching from the transport vehicle by simply having the load lift itself off of the hitch to be disconnected.

### CROSS-REFERENCE TO RELATED APPLICATIONS

### i. References Cited

| | | Publication | | |
|---|---|---|---|---|
| Cited Patent | Filing Date | Date | Applicant | Title |
| U.S. Pat. No. | Dec. 5, 2013 | Aug. 2, 2016 | Parker, Peter M | Lift for |
| 9,403,469 | | | | attachment |
| | | | | to vehicles |
| U.S. Pat. No. | Feb. 11, 2015 | Jul. 5, 2016 | RakAttach LLC | Hitch |
| 9,831,868 | | | | Adapter |

### BACKGROUND OF THE INVENTION

i. Many of today's vehicles are equipped with factory or after-market installed towing hitch receivers to use to tow and carry all many of items with your vehicle. Of course one of the most obvious would be the trailer that is connected to the hitch receiver via a ball hitch attachment. However there have been many other devices used with the receiver hitch method to include storage racks, bike racks, extension rack and wagons to name a few. In the preceding examples, except for the actual trailer, these are accoutrements that are attached with the intention that they would be permanently affixed for the duration of the use. For this invention I am making a hitching system that allows the device used with the hitch to be easily mounted and unmounted to the vehicle.

ii. Field of the Invention

i) The present invention relates to vehicle hitches. In this case the hitch attachment is composed of two pieces. The vehicle receiver plate and the transported device mounting plate.

ii) The present invention provides the receiver tube, mounting plate, alignment guide, and hitch support brackets.

### BRIEF SUMMARY

A simplified hitching system composed of two pieces, the receiver plate and the load bearing plate assembly carrying the load or load-subassembly. The receiver plate assembly inserts into a standard vehicle receiver hitch. The load bearing plate assembly has surface area that allows a hitch assembly to match up to the receiver assembly and by a utilizing a design that forces the centering of the hitch assembly enables the load bearing plate assembly to be lowered onto the receiver assembly perfectly centered and capable of carrying the load of the load or load sub-assembly.

### BRIEF DESCRIPTION OF THE SEVERAL VIEWS OF THE DRAWING(S)

FIG. 1 shows the vehicle receiver plates assembly. This view is from the back of the vehicle toward the hitch

FIG. 2 show the load bearing plate assembly with alignment plate and support braces. This is from the vehicle view.

FIG. 3 shows the hitch assembly on the left before it is moved to the receiver assembly. The receiver assembly is on the right awaiting the lowering of the hitch assembly on to the receiver assembly.

FIG. 4 show the hitch assembly and the receiver assembly properly joined for transporting the load

FIG. 5 shows a more detailed view of the support bracket and the alignment v.

### DETAILED DESCRIPTION OF THE INVENTION

Vehicles are known which have a hitch tube shaft on the bottom of the vehicle which allows for the insertion over receivers that allow for the utilization of the vehicle for all manner of purposes. Initially designed to facilitate the securing of towed trailers for transport however they have been adapted to allowing for the securing of other accoutrements that can be inserted into a receiver style trailer hitch on a vehicle. The receiving mechanism for many of these other users provide for the piece of equipment to be inserted into the vehicle receiver assembly and secured in a semi-permanent state until removed when no longer needed. The devices are intended to be use for their specific purpose then removed when no longer needed. An example would be a bike rack. This device is attached to the receiver with the intent that it would be kept in place for the duration of the use. The bikes may be mounted and unmounted for interim use however the bike rack assembly would stay affixed to the vehicle until there was no longer a need to transport the equipment. When it is removed there a defined amount of effort needed to remove the bike rick and likewise the same amount of effort needed to re-attach it, this is not something done routinely during the course of the event.

Another example would be a cargo rack. Although there is prior art showing cargo racks that folds up while still attached to the vehicle the devices are still intended to not be mounted and unmounted to the vehicle in a quick or easy manner. It is not something you would do in the course of transporting some equipment.

To overcome these limitations my invention is a receiver assembly that could be permanently mount to the transport vehicle that is small and not cumbersome but which allows a device to be lowered on the receiver and secured to the vehicle with a simple pin, allowing the device to be mounted to the transport vehicle quickly with easy mounting and unmounting.

### SUMMARY

Prior art discloses all manner of equipment and carries that can be mounted to a transport vehicle by utilizing the widely adopted hitches with either two inch or one inch receiver assemblies mounted to the vehicle.

The overall objective of this invention is to provide a compact comprehensive method to provide a means for the easy mounting and unmounting of specific accoutrements to a vehicle.

### DETAILED DESCRIPTION

While the following description details the preferred embodiments of the present invention, it is to be understood that the invention is not limited in its application to the details of construction and arrangement of the parts illustrated in the accompanying drawings, since the invention is capable of other embodiments and of being practiced in various ways. These drawings are intended to be illustrative of the intent of the invention and are not indicative of final designs or implementations.

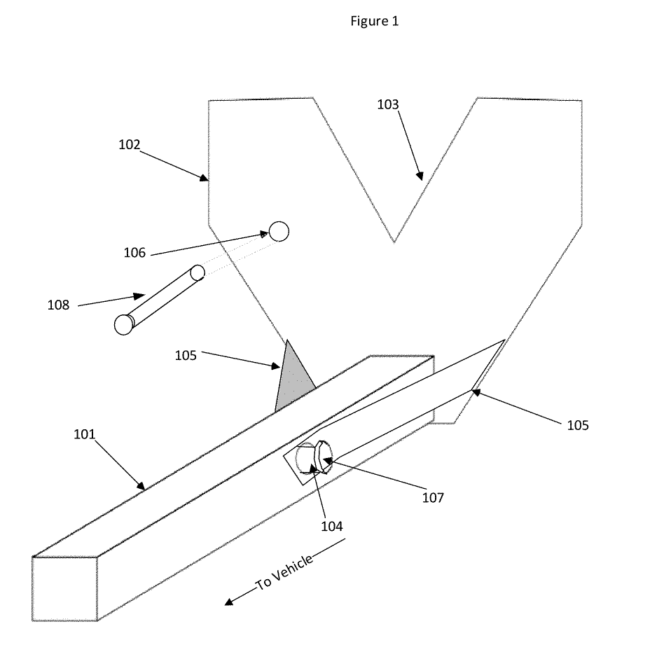

The hitch as presented is composed of two primary pieces. The receiver plate which is attached to the vehicle and the load bearing plate assembly which is mated to the receiver plate. I will first discuss the receiver hitch as displayed in FIG. 1. The first component is the mounting stem 101 which is inserted into the hitch receiver assembly and ultimately secures the receiver plate 102 to the transport vehicle. The receiver plate 102 is the primary load carrying device for the hitch assembly and facilitates the easy mounting of the load assembly. The V groove 103 allows for the self-centering of the load assembly when the two pieces are mated together and the load assembly is lowered onto the receiver assembly. This groove receives a protruded V shape from load assembly. The stabilizing braces 105 are affixed to the receiver plate and bolted through the receiver assembly and hitch receiver via a connection aperture. The stabilizing braces reduce the effects of the rotational forces present when carrying wider loads. Once load and receiver assemblies are connected they are secured via pin 108 inserted into the connection aperture 106 in both plate assemblies. This prevents the load from becoming separated from the receiver assembly during transport

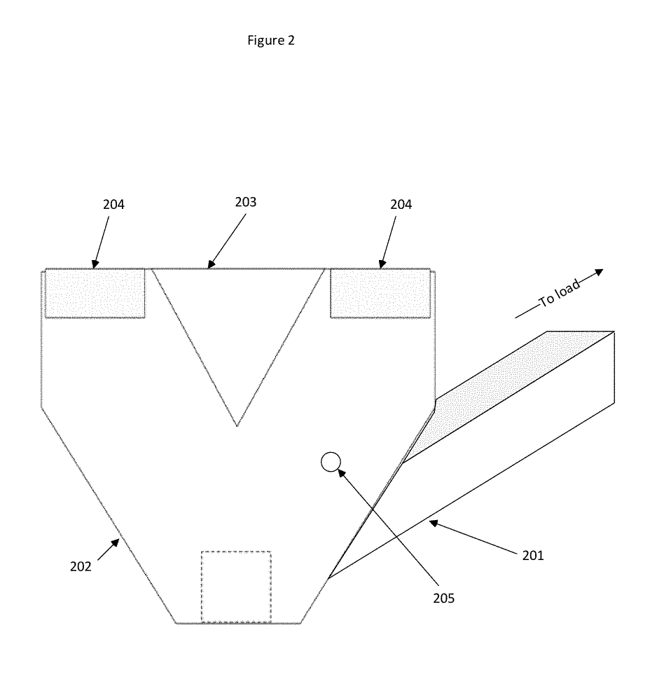

The load assembly, as presented in FIG. 2, is composed of the main support member 201 which is affixed to the mounting plate 202. The mounting plate has two primary components, the alignment V 203, and the support brackets 204. The primary role of the alignment V 203 is to ensure the plates align and center themselves when the load is lowered onto the receiver plate assembly. The support brackets 204 provide the primary support for the load. Ideally this hitching method works with a load carrier that is capable of lowering itself onto the hitch receiver assembly. Once this load assembly is married to the receiver assembly a pin is inserted through the plate connection aperture 205 to prevent the load from becoming separated from the receiver assembly during transport

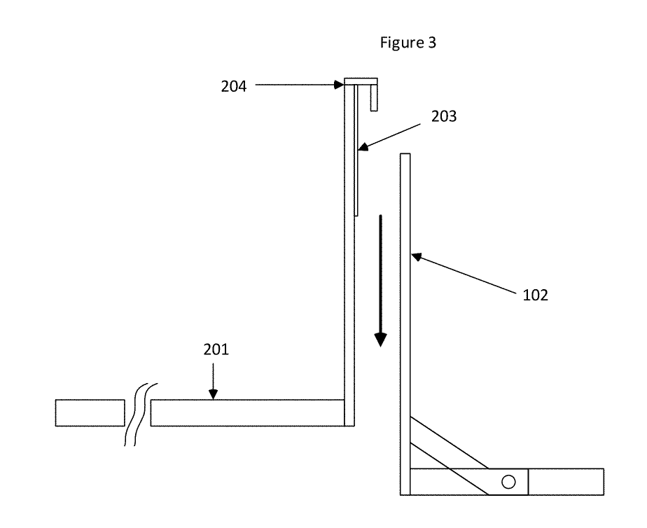

FIG. 3 show the relationship of the two assemblies before the load assembly is lowered onto the receiver assembly. Once the load, which is attached to the load support is, is positioned close to the receiver plate the load can be lowered, by whatever means incorporated into the load, on the receiver plate assembly. The protruded V of the load plate assembly will then force the proper alignment of the two plates after the load assembly is fully lowered and load brackets 204 are resting on the receiver plate assembly and the load is carried by the receiver assembly.

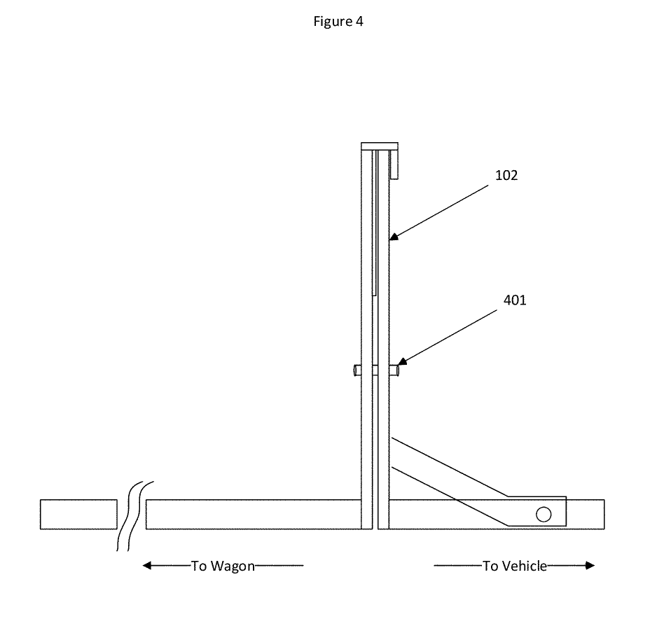

FIG. 4 demonstrates the connected hitch assembly with the load assembly lowered and resting on the receiver assembly. Once weight of the load is being fully carried by the receiver assembly 102 then a pin is inserted through a connection aperture in both plate assemblies. The pin prevents the load from becoming separated.

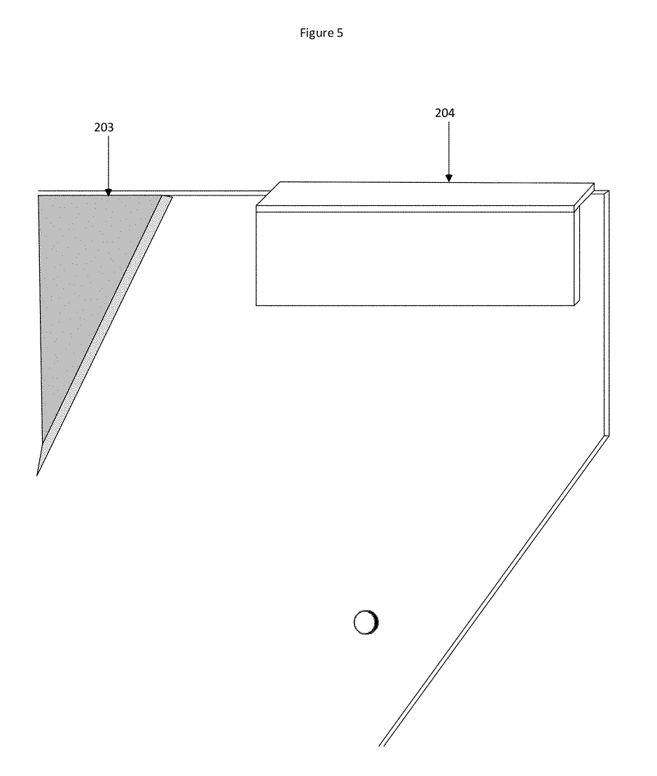

FIG. 5 provides a closer view of the load plate assembly specifically the load brackets 204. The load bracket assemblies are constructed to have a slight larger gap then the receiver plate assembly thereby providing a secure and snug connection once the load assembly has been lowered onto the receiver plate assembly. The alignment V 203 is centered onto the load plate assembly and is the same as or slighter thicker width of the receiver plate assembly allowing for both assemblies to properly align once the load assembly plate is lowered onto the receiver plate assembly.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventor contemplates the various aspects of the disclosure in any number of claim forms. For example, while only one aspect of the disclosure is recited as a means-plus-function claim under 35 U.S.C. §112, ¶13, other aspects may likewise be embodied as a means-plus-function claim, or in other forms, such as being embodied in a computer-readable medium. (Any claims intended to be treated under 35 U.S.C. §112, ¶13 will begin with the words “means for”.) Accordingly, the applicant reserves the right to add additional claims after filing the application to pursue such additional claim forms for other aspects of the disclosure.

It will be understood that various changes in the details, materials, and arrangements of the parts which has been described and illustrated above in order to explain the nature of this invention may be made by those skilled in the art without departing from the principle and scope of the invention as recited in the following claims.

What is claimed is:

1. A vehicle hitch system comprising;
(a) a receiver plate assembly inserted into to a standard vehicle hitch receiver;
(b) the load bearing assembly plate permanently mounted to the load or to a load sub-assembly;
(c) a means for allowing for the self-centering of the load bearing assembly plate to the receiver plate assembly;
(d) a duality of support brackets affixed to the top of the load bearing plate allowing for the load to be lowered and rested upon said receiver plate assembly; and
(e) a means for securing the attachment the two plate assemblies via a connection aperture on both plate assemblies allowing for the insertion of a required locking pin through the apertures to prevent separation.

2. A method for providing a vehicle hitch system;
(a) constructing a receiver plate assembly for insertion into to a standard vehicle hitch receiver:
(b) providing the means for attaching the load bearing assembly plate mounted to the load or to a load sub-assembly;
(c) providing a means for allowing the self-centering of the load bearing assembly plate to the receiver plate assembly via protruded V structure of the load plate assembly;
(d) providing a duality of support brackets affixed to the top of the load bearing plate allowing for the load to be lowered and rested upon said receiver plate assembly; and
(e) providing a means for securing the connection between the two plate assemblies via a connection aperture on both plate assemblies allowing for the insertion of a locking pin through the apertures.
